(19) United States
(12) Patent Application Publication
(10) Pub. No.: US 2022/0138754 A1
(43) Pub. Date: May 5, 2022

(54) SYSTEMS AND METHODS FOR DETECTING SUSPECT ACTIVITY OVER A COMPUTER NETWORK

(71) Applicant: Mastercard International Incorporated, Purchase, NY (US)

(72) Inventors: James David Lorenz, Ballwin, MO (US); Sravanthi Vanga, Ballwin, MO (US); John Eck, St. Louis, MO (US); Howard Fields, Wilton, CT (US); Theresa Mendello, Tuxedo, NY (US); Gang Sun, Chesterfield, MO (US); Mateo Arbelaez, Danbury, CT (US)

(21) Appl. No.: 17/513,616

(22) Filed: Oct. 28, 2021

Related U.S. Application Data
(60) Provisional application No. 63/108,241, filed on Oct. 30, 2020.

(51) Int. Cl. G06Q 20/40

(52) U.S. Cl. CPC G06Q 20/4016; G06Q 20/405; G06Q 20/407

(57) ABSTRACT

A computing system for initiating a suspect activity alert is described. The computing system includes at least one processor in communication with at least one memory. The at least one processor is programmed to receive transaction data associated with a plurality of processed transactions and receive rules data comprising at least one indicator of suspect activity. The at least one processor is also programmed to determine a first portion of the rules data to associate with a first portion of the transaction data and determine whether the first portion of the transaction data complies with the first portion of the rules data. The at least one processor is further configured to generate a suspect activity alert message upon determining the first portion of the transaction data does not comply with the first portion of the rules data.

### CROSS-REFERENCE TO RELATED APPLICATIONS

This application claims the benefit of priority to U.S. Provisional Patent Application No. 63/108,241, filed Oct. 30, 2020, entitled “SYSTEMS AND METHODS FOR DETECTING SUSPECT ACTIVITY OVER A COMPUTER NETWORK”, the entirety of which is hereby incorporated by reference.

### BACKGROUND

The present application relates generally to a technology for detecting suspect activity over a computer network and, more specifically, to network-based systems and methods for detecting money laundering activities from transaction data processed over a payment network.

Financial institutions, and other entities that work with financial institutions, have an obligation to identify and report possible money laundering activities that may be occurring over their computer networks. Money laundering is an illegal process that can be described as passing illegally-obtained money through various banking transfers and/or commercial transactions in order to conceal the origin of the money. Money laundering is also frequently used to describe other illegal processes such as misusing financial systems and committing other forms of financial and/or business crime. Currently, a manual and labor-intensive process is used in an effort to comply with the reporting requirements noted above. This necessitates manually combining and analyzing data looking for money laundering patterns. However, identifying money laundering patterns in real-time or near real-time within huge amounts of financial transaction data is extremely difficult, if not impossible, in many instances.

Accordingly, a system and/or method is needed that is able to collect a large amount of transaction data, apply computer implemented rules to the data, analyze the data, identify trends within the data that are indicative of money laundering activities, and identify parties that are experiencing these identified trends as being parties likely engaged in money laundering activities in real-time. Moreover, a system and method is needed that may also determine if the parties experiencing these identified trends have adequate monitoring systems in place to detect future money laundering activities.

### BRIEF DESCRIPTION

In one aspect, a computing system for initiating a suspect activity alert is described. The computing system includes at least one processor in communication with at least one memory. The at least one processor is programmed to receive transaction data associated with a plurality of processed transactions and receive rules data including at least one indicator of suspect activity. The at least one processor is also programmed to determine a first portion of the rules data to associate with a first portion of the transaction data and determine whether the first portion of the transaction data complies with the first portion of the rules data by analyzing the first portion of the transaction data and the first portion of the rules data. The at least one processor is further configured to generate a suspect activity alert message upon determining the first portion of the transaction data does not comply with the first portion of the rules data.

In another aspect, a computer-implemented method for initiating a suspect activity alert is described. The method is implemented by at least one suspect activity detection (SAD) computing device including at least one processor in communication with at least one database. The method includes receiving transaction data associated with a plurality of processed transactions, receiving rules data including at least one indicator of suspect activity, and determining a first portion of the rules data to associate with a first portion of the transaction data. The method also includes determining whether the first portion of the transaction data complies with the first portion of the rules data by analyzing the first portion of the transaction data and the first portion of the rules data and generating a suspect activity alert message upon determining the first portion of the transaction data does not comply with the first portion of the rules data.

In yet another aspect, a non-transitory computer-readable storage medium having computer-executable instructions embodied thereon is provided. When executed by at least one suspect activity detection (SAD) computing device, including at least one processor in communication with at least one database, the computer-executable instructions cause the SAD computing device to receive transaction data associated with a plurality of processed transactions, receive rules data including at least one indicator of suspect activity, and determine a first portion of the rules data to associate with a first portion of the transaction data. The computer-executable instructions also cause the SAD computing device to determine whether the first portion of the transaction data complies with the first portion of the rules data by analyzing the first portion of the transaction data and the first portion of the rules data and generate a suspect activity alert message upon determining the first portion of the transaction data does not comply with the first portion of the rules data.

### BRIEF DESCRIPTION OF THE DRAWINGS

FIGS. 1-8 show example embodiments of the methods and systems described herein.

FIG. 1 is a schematic diagram illustrating a suspect activity detection (SAD) computing device for detecting suspect activity in communication with payment processing system in accordance with the present disclosure.

FIGS. 2A, 2B, and 2C are block diagrams of example embodiments of a SAD computing system including the SAD computing device shown in FIG. 1.

FIGS. 3A and 3B are data flow diagrams illustrating an example process of determining suspect activity and modifying rules by the SAD computing device shown in FIG. 1.

FIGS. 4A, 4B, and 4C are simplified diagrams of example database entries that may be generated and/or utilized by the SAD computing device shown in FIG. 1.

FIG. 5 is an example configuration of a client system shown in FIG. 2A.

FIG. 6 is an example configuration of a server system shown in FIG. 2A.

FIG. 7 is a diagram of components of one or more example computing devices that may be used in the SAD computing system shown in FIG. 2A.

FIG. 8 is a simplified diagram of an example method for detecting suspect activity and generating alerts using the SAD computing system shown in FIG. 2A.

Like numbers in the Figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION

The systems and methods described herein are directed to detecting suspect activity or activities conducted over a computer network and, more specifically, to a network based system and method for detecting money laundering activity or activities from transaction data of a plurality of transactions processed over a payment network (e.g., multiple aggregated data sets). In the example embodiment, the plurality of processed transactions includes dual message transactions (e.g., transactions including an authorization message and/or a clearing message), debit transactions (e.g., carried out with a credit card and/or debit card), and prepaid transactions that have been processed by a payment processor.

For example, these messages may be in ISO 8583 or ISO 20022 message formats for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

The systems and methods described herein may be performed by a suspect activity detection (SAD) computing device included within an SAD computing system. The SAD computing device may be in communication with a payment processor and/or at least one database associated with a payment processor (e.g., sometimes referred to as a data warehouse).

In detecting suspicious activity, the SAD computing device may determine a subset of transaction data from a larger set of transaction data that satisfies a set of rules for identifying transactions that are indicative of suspicious activity (e.g., money laundering activity). As used herein, transaction data that “satisfies” a rule is transaction data that meets standards and/or conditions and/or triggers set forth in a rule, and therefore may be an indicator of money laundering activities. In other words, the SAD computing device may determine whether a portion of transaction data complies with a rule of a set of rules specified by rules data as being applicable to the portion of transaction data. For example, SAD computing device may compare certain transaction data with rules data regarding at least one of: (i) high risk cross border activity; (ii) high risk merchant categories; (iii) unusual patterns involving a customer's total credit refunds, and customer's total cash back at a POS; (iv) change in behavior involving a customer's total domestic activity over time, and a customer's total cross border activity over time; and (v) high risk customers total domestic activity and cross border activity. The SAD computing device may then, upon determining the transaction data is not in compliance with (e.g., satisfies) at least one rule, generate a suspect activity alert message, and may identify the customer as potentially involved in money laundering activities. The SAD computing device therefore is configured to process and generate alerts which will help identify customers (e.g., issuing and/or acquiring banks) that are prone to money laundering risk. In the example embodiment, the customer may include at least one of an issuer bank, an acquirer bank, and a third party representing either the issuer bank or the acquirer bank depending on the context of the transaction.

The suspect activity alert message may be transmitted to, as an example, a compliance team of operators to verify whether the transaction data truly indicates suspect activity. In some embodiments, operators may modify rules in order for the SAD computing device to better identify suspect activity. In some embodiments, the SAD computing device may utilize artificial intelligence techniques and machine learning to better identify suspect activity in future or subsequent reviews. In the example embodiment, the SAD computing device is configured to identify suspect activities that can be indicators of money laundering patterns. In some embodiments, the SAD computing device may be configured to identify other suspect activity or patterns in data regarding, for example, sanctions and/or compliance. In addition, the SAD computing device may determine whether the customer has adequate monitoring controls in place to detect future suspect activity. If adequate controls are not in place, the SAD computing device may provide recommendation or deploy additional computer resources to the customer for future monitoring for such suspect activity. In some embodiments, the SAD computing device may deploy additional computational resources (e.g., deploying additional servers for use in monitoring activities and applying rules) to provide additional monitoring controls for those customers that have been identified as having experienced past suspect activity or who are located in high risk areas.

In the example embodiment, five sets of network rules may be used to drive alert generation: High Risk Cross Border Activity, High Risk Merchant Categories, Unusual Patterns, Change in Behavior, and High Risk Customers. In some embodiments, more or less sets of network rules may be used. The rules capture changes in activity by aggregated transaction volume and/or transaction count, changes in activity over time, and changes in activity as compared to peers. The rules are applied to either the total aggregated transaction volume and/or transaction count of the customer or segmented by type of activity such as Automated Teller Machine (ATM), Prepaid, POS and ecommerce, or combinations thereof. The rules are each assigned a rule objective, a rule name, an alert level (e.g., customer, customer CGI, etc.), an alert type (e.g., domestic high risk, cross border high risk, issuing/acquiring, total credits, total cash back (POS), etc.), a rule type (e.g., issuing/acquiring high risk cross border transactions, issuing/acquiring high risk transactions, issuing/acquiring credit refunds, issuing/acquiring domestic transactions, high risk issuing/acquiring domestic transactions, etc.), an evaluation level (e.g., customer, etc.), an evaluation trigger (e.g., monthly activity, previous three months activity, etc.), detection logic (e.g., specific rule/threshold logic), a recurrence frequency (e.g., monthly), default values (e.g., to indicate if cross border activity is being monitored by a given rule (e.g., Cross Border=Yes or No)), data source(s) (e.g., clearing, debit), and permutations (e.g., data from data source(s) one or more rules will be applied to).

Alerts are generated from the SAD computing device when a customer's activity exceeds set suspect activity thresholds (percentage, amount, count, increase over time) for each of the rules. Each month, alerts are generated from preceding month's data. Alerts are assigned to analysts for further investigation to determine if they are legitimate or false positive. Alert outputs are stored in database (e.g., database 110) for a retention period of 5 years. Analysts may compare the customer alerts to previous alerts to determine if the customer has been subject of prior alerts, if the alert is related to prior alert or a different typology triggered.

The technical problems addressed by the disclosure include at least one of: (i) inability to identify parties (e.g., banks) using computer networks to engage in money laundering activities; (ii) inability to apply rules to computer messages communicated over computing networks for identifying money laundering activities; (iii) inability to refine rules using artificial intelligence and machine learning for identifying money laundering activities; (iv) ability to automate the task of identifying money laundering activities and avoid substantial human resources necessary to complete a manual and labor-intensive processes of reviewing such transaction data; (v) ability to avoid substantial human resources necessary to parse transaction data to identify potential money laundering patterns; (vi) inability to determine money laundering patterns from bulk data in real-time; and (vii) inability to automatically generate detailed alerts upon detecting potential money laundering patterns and deploying computational resources as needed to address future money laundering detection.

The resulting technical benefits and effects achieved by the systems and methods of the disclosure include at least one of: (i) dynamically combining transaction data in real-time to simplify determining potential money laundering patterns; (ii) parsing transaction data in real-time to identify potential money laundering patterns; (iii) ability to determine potential money laundering patterns from bulk data in real-time; (iv) automatically generating detailed alerts upon detecting potential money laundering patterns in real-time; (v) ability to identify parties (e.g., banks) using computer networks to engage in money laundering activities; (vi) ability to apply rules to computer messages communicated over computing networks for identifying money laundering activities; (vii) ability to refine rules using artificial intelligence and machine learning for identifying money laundering activities; (viii) ability to automate the task of identifying money laundering activities and avoid substantial human resources necessary to complete a manual and labor-intensive processes of reviewing such transaction data; (ix) ability to avoid substantial human resources necessary to parse transaction data to identify potential money laundering patterns; and (x) ability to automatically generate detailed alerts upon detecting potential money laundering patterns and deploying computational resources as needed to address future money laundering detection.

The systems and methods directed to the SAD computing system described herein may be implemented using computer programming or engineering techniques including computer software, firmware, hardware, or any combination or subset thereof, wherein the technical effect may be achieved by performing at least one of the following steps: (i) receiving transaction data associated with a plurality of processed transactions; (ii) receiving rules data including at least one indicator/indication of suspect activity; (iii) determining a first portion of the rules data to associate with a first portion of the transaction data; (iv) determining whether the first portion of transaction data complies with the first portion of the rules data by analyzing the first portion of transaction data and the first portion of the rules data; and (v) generating a suspect activity alert message upon determining the first portion of transaction data does not comply with the first portion of the rules data.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality. The following detailed description illustrates embodiments of the disclosure by way of example and not by way of limitation. It is contemplated that the disclosure has general application to providing a suspect activity detection computing system/device to determine suspect activity from transaction data.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PCAs), and key fobs.

As used herein, the term “database” may refer to either a body of data, a relational database management system (RDBMS), or to both. Further, “database” may refer to a cloud database (e.g., Microsoft Azure). A database may include any collection of data including hierarchical databases, relational databases, flat file databases, object-relational databases, object oriented databases, and any other structured collection of records or data that is stored in a computer system. The above examples are for example only, and thus, are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database implementation (e.g., relational, document-based) may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, transaction data includes any account, transaction, merchant, issuer, authorization, and/or clearing data associated with a transaction. Transaction data may include account identifiers (e.g., payment account numbers (PANs), bank identifier numbers (BINs), customer identification numbers (CIDs), etc.), account information (e.g., whether accounts are in good standing or bad standing), payment card types, transaction amounts, item identifiers, merchant identifiers, merchant locations, merchant category codes, issuing bank, authorization messages and/or clearing messages, transaction identifiers, etc.

As used herein, money laundering refers to an illegal process of passing illegally-obtained money through various banking transfers and/or commercial transactions in order to conceal the origin of the money, or other illegal processes such as misusing financial systems and other forms of financial and/or business crime.

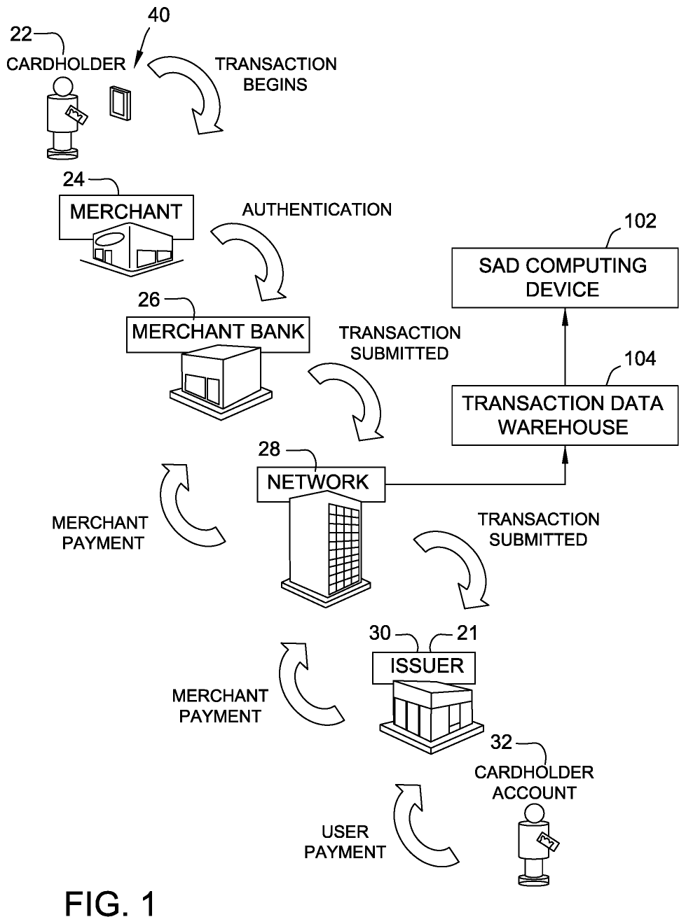

FIG. 1 illustrates a schematic diagram of a suspect activity detection (SAD) computing device 102 in communication with a payment processing network 28 that is used to process payment transactions initiated by a cardholder 22 at a merchant 24. SAD computing device 102 is configured to collect transaction data from processed payment transactions and dynamically detect suspect activity, such as money laundering activity. Embodiments described herein may relate to a transaction card system, such as a payment card payment system using the Mastercard interchange network and/or third party payment processing systems and networks. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.).

In the exemplary embodiment, SAD computing device 102 is communicatively coupled to processing network 28. SAD computing device 102 is configured to receive transaction data from processing network 28 to detect suspect activity in real-time and generate alerts related to the suspect activity. In the exemplary embodiment, payment transactions may include dual message transactions, debit transactions, and prepaid transactions. As used herein, processing network 28 may be directly connected to SAD computing device 102, or may be indirectly connected to SAD computing device 102 through a gateway system (not shown).

In the example embodiment, a financial institution called the “issuer” or “issuing bank” issues an account, such as a credit card account, a debit account, or a prepaid card account to a cardholder 22, who uses the account to tender payment for a purchase from a merchant 24. In some embodiments, cardholder 22 presents a payment card and/or a digital wallet to merchant 24 using a cardholder computing device (also known as card-present transactions). In another embodiment, cardholder 22 does not present a digital wallet and instead performs a card-not-present transaction. For example the card-not-present transaction may be initiated via a digital wallet application, person to person (e.g., a push payment from one cardholder account to another cardholder account), through a website or web portal, via telephone, or any other method that does not require the cardholder to present a physical payment card to merchant 24 (e.g., via swiping or inserting the payment card and/or scanning the digital wallet).

To accept payment with the transaction card, merchant 24 establishes an account with a financial institution that is part of the financial payment system. This financial institution is usually called the “merchant bank,” the “acquiring bank,” or the “acquirer.” In some embodiments, cardholder 22 tenders payment or a purchase using a transaction card at a transaction processing device 40 (e.g., a point of sale device), then merchant 24 requests authorization from a merchant bank 26 for the amount of the purchase. The request is usually performed through the use of a point-of-sale terminal, which reads account information of cardholder 22 from a magnetic stripe, a chip, barcode, or embossed characters on the transaction card (e.g., a debit card or a prepaid card) and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” “an acquiring processor,” or a “third party processor.”

Using processing network 28, computers of merchant bank 26 or merchant processor will communicate with computers of an issuer bank 30 to determine whether an account 32 of cardholder 22 is in good standing and whether the purchase is covered by an available credit line of cardholder 22. Based on these determinations, the request for authorization will be declined or accepted. If the request is accepted, an authorization code (e.g., included in an authorization message) is issued to merchant 24. An authorization message includes a transaction identifier associated with the transaction and an indicator indicating that the transaction was authorized. If the request is not accepted, an authorization message includes a transaction identifier associated with the transaction and an indicator indicating that the transaction was declined. In the example embodiment, an authorization message is formatted according to ISO 8583 network messaging protocol or the equivalent messaging protocol used by the payment card processing network.

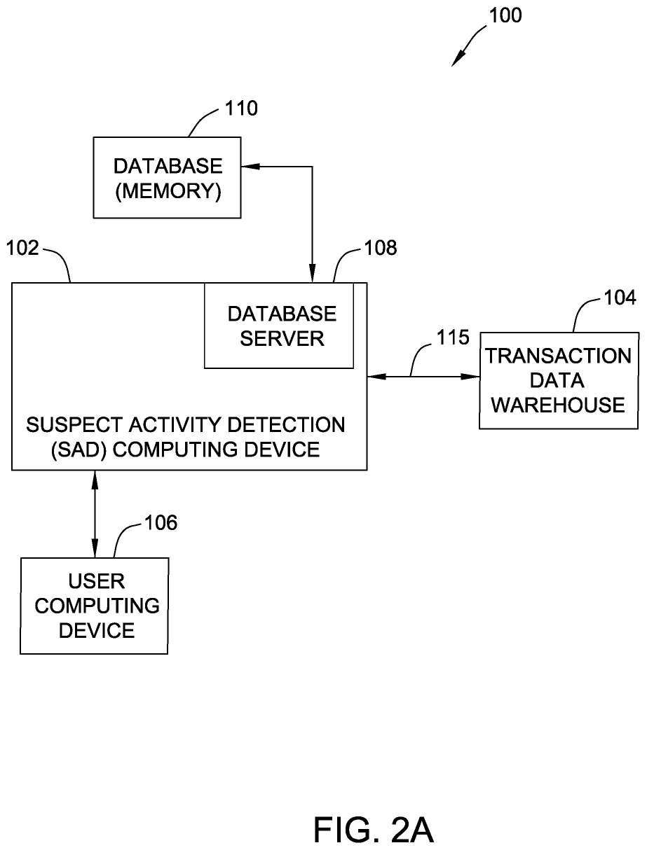

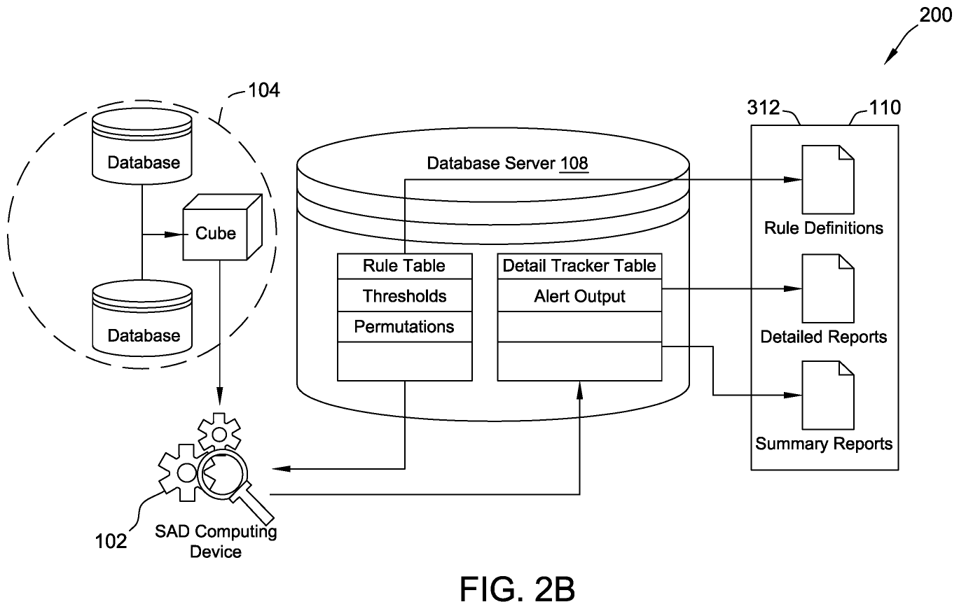

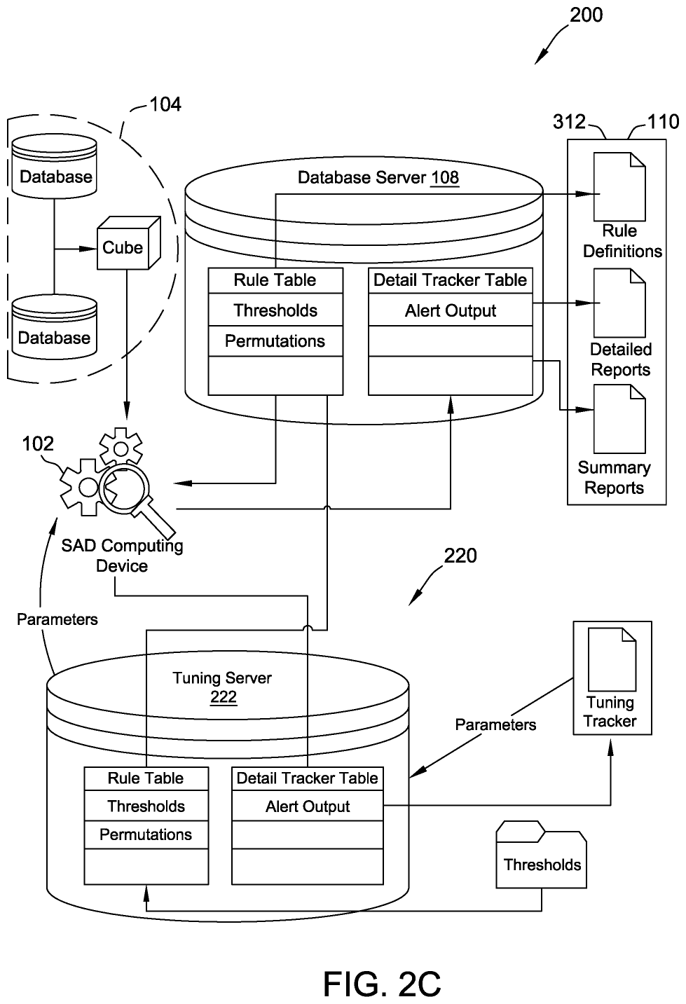

When a request for authorization is accepted, the available credit line of account 32 of cardholder 22 is decreased. In another example, when a request for authorization is accepted an amount is deducted from a deposit account (e.g., authorization of cardholder 22 payment via a debit card results in the amount being deducted from the deposit account). Normally, a charge for a payment card transaction is not posted immediately to account 32 of cardholder 22 because certain rules do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Processing network 28 and/or issuer bank 30 stores the transaction card information, such as a type of merchant, amount of purchase, date of purchase, etc. in a database 110 (shown in FIG. 2).

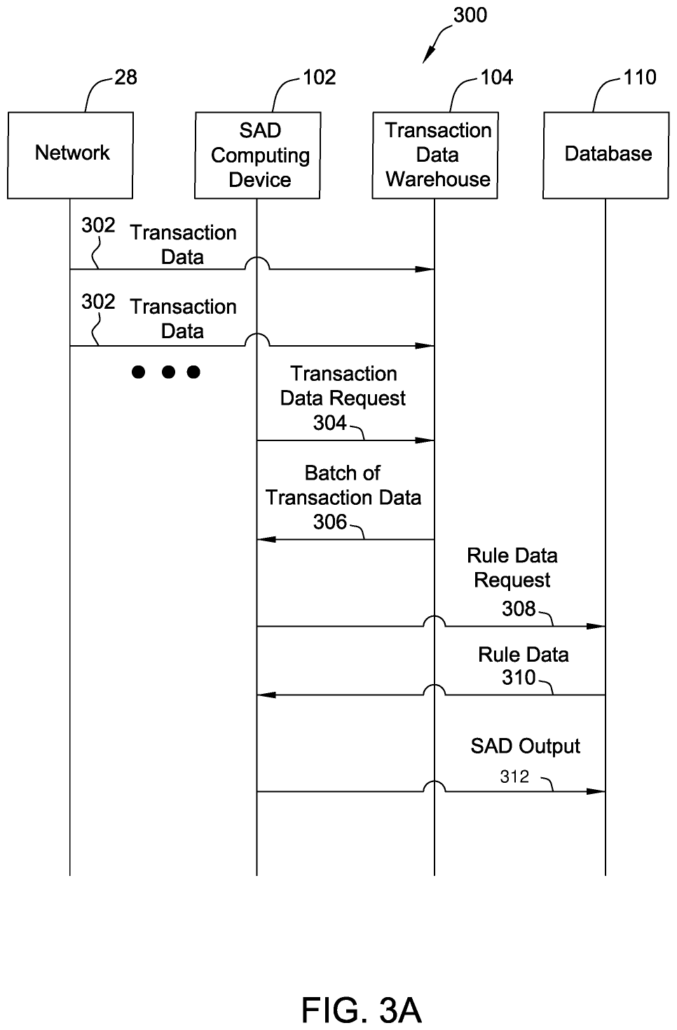

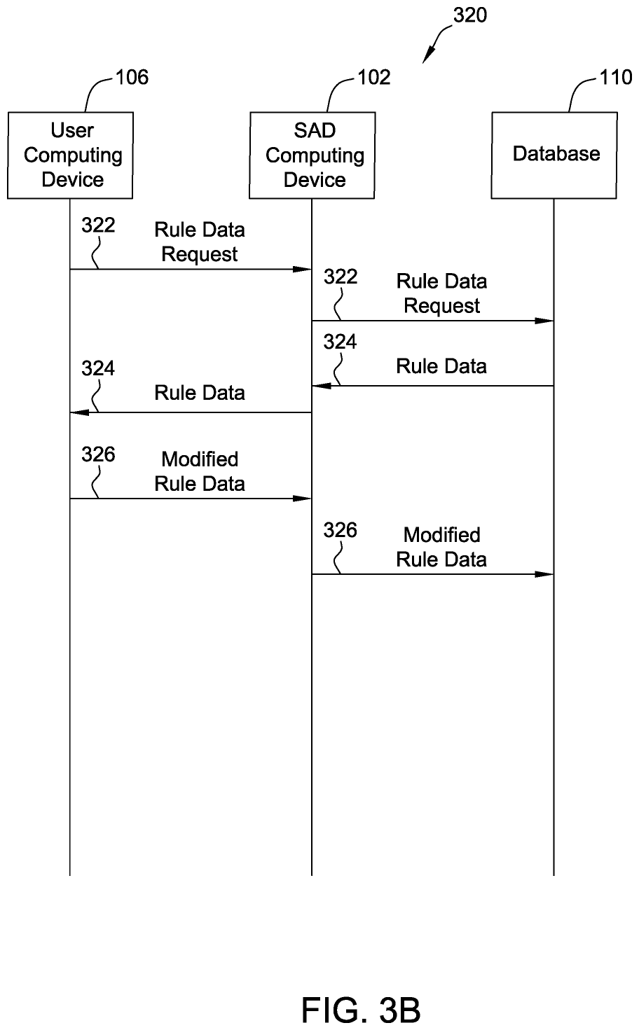

After a purchase has been made, a clearing process occurs to transfer additional transaction data related to the purchase among the parties to the transaction, such as merchant bank 26, processing network 28, and issuer bank 30. More specifically, during and/or after the clearing process, additional data included in a clearing message, such as a time of purchase, a merchant name, a type of merchant, purchase information, cardholder account information, a type of transaction, a transaction identifier, information regarding the purchased item(s) (e.g., product identifiers), information regarding container(s) of the purchased item(s) (e.g., container identifiers), and/or other suitable information, is associated with a transaction and transmitted between parties to the transaction as transaction data (e.g., transaction data 302 as shown in FIG. 3), and may be stored by any of the parties to the transaction. In some embodiments, a clearing message is formatted according to ISO 8583 network messaging protocol or the equivalent messaging protocol used by the payment card processing network.

After a transaction is authorized and cleared, the transaction is settled among merchant 24, merchant bank 26, and issuer bank 30. Settlement refers to the transfer of financial data or funds among account of merchant 24, merchant bank 26, and issuer bank 30 related to the transaction. Usually, transactions are captured and accumulated into a “batch,” which is settled as a group. More specifically, a transaction is typically settled between issuer bank 30 and processing network 28, and then between processing network 28 and merchant bank 26, and then between merchant bank 26 and merchant 24.

As described above, the various parties to the payment card transaction include one or more of the parties shown in FIG. 1 such as, for example, cardholder 22, merchant 24, merchant bank 26, processing network 28 (also referred to herein as payment processor 28), issuer bank 30, and/or an issuer processor 21.

Occasionally, transactions processed by processing network 28 are disputable (e.g., fraudulent transactions, transactions carried out with bad standing accounts, or otherwise disputable by the account holders or issuer), and chargebacks may be necessary to correct the disputable transactions (e.g., by crediting accounts associated with the disputable transactions such that the cardholders associated with the accounts are not accountable for the disputable transactions). In known chargeback processing systems, cardholder 22, users associated with processing network 28, and/or users associated with issuer 30 determine that a disputable transaction has taken place and may alert issuer 30 of the payment card and/or processing network 28 associated with the payment card to initiate the chargeback process.

As described above, financial institutions have an obligation to identify and report possible money laundering activities on their networks, such as network 28. Typical money laundering detection processes are arduous and require significant amounts of human effort. SAD device 102 uses rules/requirements (e.g., as specified in a database 110) to determine potential money laundering activity on network 28 and automatically generate an alert to notify an operator of the activity on network 28 that resembles indicators of money laundering.

FIG. 2A is a block diagram of an example SAD computing system 100, including SAD computing device 102, which is configured to receive transaction data associated with a plurality of processed payment transactions, determine whether a portion of the transaction data potentially indicates money suspect (e.g., money laundering) activity, and generate a suspect activity alert message.

SAD computing device 102 is in communication with a database 110 associated with processing network 28 (shown in FIG. 1), using a network 115, and a user computing device 106. In the example embodiment, user computing device 106 (e.g., a smartphone, laptop, tablet, etc.) is configured to receive user inputs from, and display information to, a user thereof. For example, a user of user computing device 106 may receive, at user computing device 106, an alert message indicating suspect activity. As another example, a user at user computing device 106 may be able to access and modify rules data as described herein.

The portion of the transaction data warehouse 104 leveraged by SAD computing device 102 is a database configured to store, as examples, transaction data, authorization message data, clearing message data, transaction card data (e.g., issued account identifiers and status), chargeback data, and/or other data may include a single database having separated sections or partitions, or may include multiple databases, each being separate from each other. For example, in some embodiments, database 110 may be included in data warehouse 104. In one embodiment, data warehouse 104 is stored on SAD computing device 102 and can be accessed by a payment network server. Access to this portion of the data warehouse 104 is controlled by SAD computing device 102 to limit the display of data to authorized users associated with SAD computing device 102. In an alternative embodiment, data warehouse 104 is stored remotely from SAD computing device 102 and may be non-centralized. In some embodiments, data warehouse 104 stores transaction data generated over the processing network including data relating to merchants, consumers, account holders, prospective customers, issuers, acquirers, and/or purchases made. In some embodiments, data warehouse 104 also stores account data including one or more primary account numbers (PANs), other account identifiers, and transaction information. Data warehouse 104 may also store merchant information including a merchant identifier that identifies each merchant registered to use the network, and instructions for settling transactions including merchant bank account information. Data warehouse 104 may also store purchase data associated with items being purchased by a cardholder from a merchant, authorization request data, authorization messages, and clearing messages.

A database server 108 is connected to database 110, which contains information on a variety of matters, as described below in greater detail. In one embodiment, centralized database 110 is stored on SAD computing device 102 and can be accessed by a payment network server. Access to database 110 is controlled by SAD computing device 102 to limit the display of data to authorized users associated with SAD computing device 102. In an alternative embodiment, database 110 is stored remotely from SAD computing device 102 and may be non-centralized. In the example embodiment, database 110 is configured to store information used by SAD computing device 102 including rules data (e.g., permutations and thresholds), and outputs from SAD computing device 102 (e.g., summarized reports and detailed reports).

Database 110 may include a single database having separated sections or partitions, or may include multiple databases, each being separate from each other. In some embodiments, database 110 stores transaction data generated over the processing network including data relating to merchants, consumers, account holders, issuers, acquirers, and/or purchases made. In some embodiments, database 110 also stores account data including one or more primary account numbers (PANs), other account identifiers, and transaction information. Database 110 may also store merchant information including a merchant identifier that identifies each merchant registered to use the network, and instructions for settling transactions including merchant bank account information. Database 110 may also store authorization request data, authorization messages, and clearing messages.

FIG. 2B is an expanded block diagram of an example SAD computing system 100, including SAD computing device 102. In the example shown in FIG. 2B, transaction data warehouse 104 includes a plurality of databases that transmit data to SAD computing device 102 from aggregated data cubes via an automated transfer process that is also included in transaction data warehouse 104. As an example, the data cube may be an online analytical processing cube specifically configured for SAD computing system 100 (e.g., to facilitate detection of money laundering and/or other suspicious activity). The cube allows SAD computing device 102 to receive aggregate customer data to facilitate network level monitoring. In the example embodiment, the cube includes 16 months of data relating to clearing and debit networks mapped to CID/ICA/BIN/Product/Transaction Type, etc. The cube serves as a source to build queries on SAD computing device 102 with various combinations of customer types and transactions methods for different rules (e.g., rules approved by regulators), as described herein. In some embodiments, queries with rules logic and calculations are embedded into a layer of SAD computing device to process and generate monthly alerts which will help identify customers (e.g., issuing and/or acquiring banks) that are prone to money laundering risk.

Further, as described herein, database 110 includes data including rule definitions to be transmitted to SAD computing device 102, along with detail reports and summary reports that are transmitted to database 110 from SAD computing device 102 (e.g., as SAD outputs 312). As shown in FIG. 2B, rule definitions, including thresholds and permutations, along with outputs from SAD computing device 102 are transmitted between SAD computing device 102 and database 110 via database server 108.

FIG. 2C is a further expanded block diagram of an example SAD computing system 100, including SAD computing device 102. FIG. 2C includes the components shown and described in FIGS. 2A and 2B, along with an additional tuning system 220 including tuning server 222 configured to facilitate tuning different parameters as described herein.

For example, thresholds are baseline values set for different transaction types based on percentage, count, amount or increase over time to determine if the alerts generated are productive. Tuning is a process done by the compliance team or delegates to evaluate which thresholds provide the most productivity for alert generation. Typically, this requires a minimum of three iterations, which include tweaking thresholds set above and below the standard baseline and testing to compare the results between current thresholds and new ones. If a rule is found to produce a high number of false positive alerts, consideration must be made to adjust thresholds. Conversely, if a rule is found not to yield any meaningful alerts, thresholds are reconsidered for modification or, the rule is either replaced or retired. In some embodiments, tuning may be performed at least in part by SAD computing device 102 itself.

After the tuning process is done, thresholds are finalized by a compliance team and/or SAD computing device 102 for each rule by customer type/service provider and by network type (Clearing/Debit) and are applied to rules for alert generation.

FIG. 3A is a data flow diagram 300 illustrating an example process of determining suspect activity by SAD computing device 102. Data warehouse 104 is configured to receive and store transaction data 302 from network 28 regarding a plurality of transactions. In the example embodiment, SAD computing device 102 is configured to request transaction data 302 via a transaction data request 304 at a predetermined frequency (e.g., once a month). In some embodiments SAD computing device 102 may request transaction data 302 upon receiving a request from a user operating user computing device 106. In some embodiments SAD computing device 102 may receive transaction data 302 directly from network 28 as transaction data 302 becomes available (e.g., during the authorization process of the transaction message).

In the example embodiment, SAD computing device 102 is configured to receive a batch of transaction data 306 including a plurality of transaction data 302. In some embodiments, batch of transaction data 306 may be stored as a data cube (e.g., a multi-dimensional array of values). For example, batch of transaction data 306 may include all transaction data 302 received by database 110 over a predetermined time period (e.g., one month). SAD computing device 102 is configured to then request rule data 310 via a rule data request 308 and receive rule data 310 from database 110. In the example embodiment, rule data 310 includes data indicating and including rules to be applied to transaction data 302 in batch of transaction data 306. In some embodiments, different rules may be applied to different portions of batch of transaction data 306 (as described below in greater detail). In some embodiments, SAD computing device 102 is configured to determine which rules included in rule data 310 are applied to which portions of batch of transaction data 306.

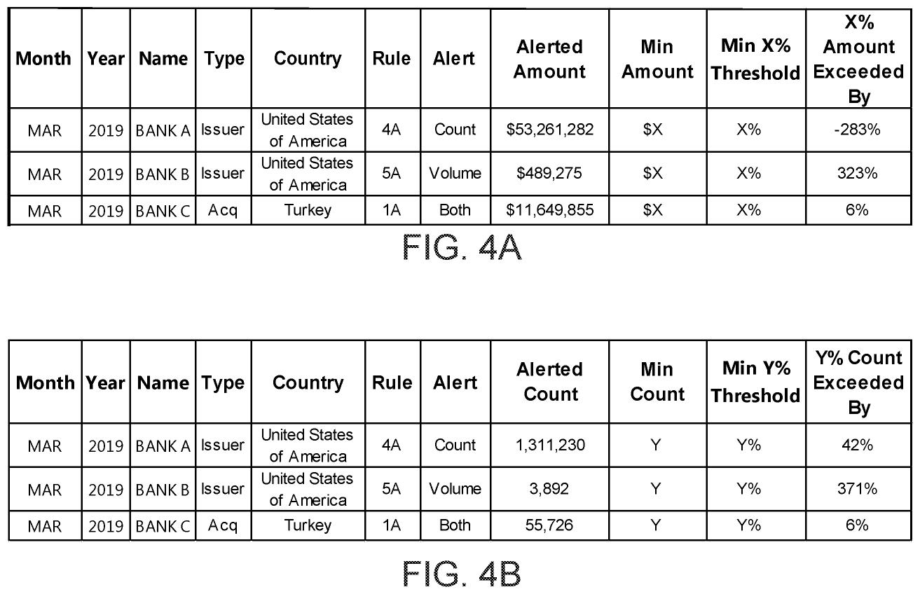

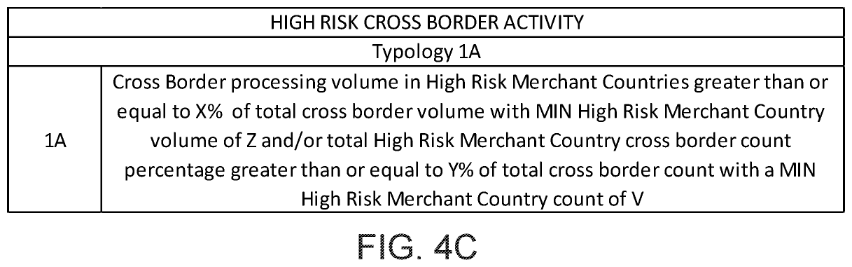

For example, as shown in FIGS. 4A and 4B, SAD computing device 102 may determine to apply Rule 1A (shown in FIG. 4C) to at least a portion of batch of transaction data 306. SAD computing device 102 may determine which rules to apply to which portions of batch of transaction data 306. In some embodiments, transaction data 302 in batch of transaction data 306, and/or rule data 310, may indicate which rules should be applied to which transactions. In some embodiments, all rules are applied to all transactions.

FIG. 4C is a simplified diagram 440 of an example description of a rule that may be included in rule data 310. When Rule 1A, as shown in FIG. 4C, is applied to transaction data by SAD computing device 102, SAD computing device 102 is configured to determine if transaction data 302 in batch of transaction data 306 satisfies Rule 1A (e.g., indicates potential money laundering activity). Rule 1A is a rule relating to cross border activity. If transaction data 302 in batch of transaction data 306 satisfies Rule 1A, transaction data 302 may represent illegal money laundering activity.

In the example shown in FIGS. 4A and 4B, three portions of transaction data 302 (for Bank A, Bank B, and Bank C) included in batch of transaction data 306 are analyzed by SAD computing device 102. FIGS. 4A and 4B demonstrate simplified examples of SAD output 312 that may be transmitted from SAD computing device 102 to database 110 as shown in FIG. 3A. In this example, for Bank C, SAD computing device 102 is configured to detect money laundering activity based on one of processing volume (e.g., a dollar amount) in high risk countries being greater than a percentage (Min X % Threshold) of total cross border volume with a total volume in high risk countries greater than a minimum amount (Z or Min Amount) and cross border count (e.g., a number of processed transactions) percentage in high risk countries greater than or equal to a percentage (Min Y % Threshold) of total cross border count with a total cross border count in high risk countries greater than a minimum amount (V or Min Count).

In this example, different rules are satisfied by transaction data 302 from different entities. Rule 4A is satisfied by Bank A, Rule 5A is satisfied by Bank B, and Rule 1A is satisfied by Bank C. In some embodiments, SAD computing device 102 is configured to apply any number of rules to any amount of transaction data 302. Different rules may be applied by SAD computing device 102 to detect, for example, high risk cross border activity, high risk merchant categories, unusual patterns, change in behavior, and/or high risk customers. SAD computing device 102 may determine a rule is satisfied by, as examples, comparing transaction data to predetermined thresholds (e.g., X % and Y % as described above, stored in data warehouse 104), comparing transaction data of an entity to its peer group's (e.g., similar entities) transaction data, and/or comparing transaction data of an entity to that entity's previous transaction data. Other examples of activity SAD computing device 102 may determine potentially indicate money laundering include a significant number of credits and/or refunds, a significant number of ATM withdrawals on the same day and/or at the same location, high frequency of round dollar amounts, multiple merchants operating out of the same address with the same merchant ID, and significant increase of activity at merchants that provide financial services (e.g., cash advances, insurance, etc.). In some embodiments, at least a portion of the activity described above may be analyzed outside of SAD computing device 102 (e.g., at another computing device and/or by a data analyst).

Using the analysis of Bank C by SAD computing device 102 as an example, SAD computing device 102 has determined Bank C has satisfied both the “Count” and “Volume” portions of Rule C (while Bank A has only satisfied “Count” and Bank B has only satisfied “Volume” as shown in the “Alert” column). Simplified outputs of SAD computing device 102 in FIGS. 4A and 4B demonstrate examples of data used and generated by SAD computing device 102. In the example of FIG. 4A, SAD computing device 102 determines Bank C satisfied the “volume” portion of Rule 1A because Bank C exceeded X % (Min X % Threshold for Rule 1A) of processing volume in high risk countries, and exceeded a minimum amount (X or Min Amount) of $X. In the example of FIG. 4B, SAD computing device 102 determines Bank C satisfied the “count” portion of Rule 1A because Bank C exceeded Y % (Min Y % Threshold for Rule 1A) of processing count (e.g., number of transactions) in high risk countries, and exceeded a minimum count in high risk countries (Y or Min Count). Accordingly, SAD computing device 102 generates an alert that Bank C satisfied “Both” (shown in Alert column) portions of Rule 1A. Other examples shown in FIGS. 4A and 4B demonstrate that Bank A satisfied the “Count” portion of an example Rule 4A, while Bank B satisfied the “Volume” portion of an example Rule 5A.

In some embodiments, rules may be applied to a total aggregated transaction volume and/or count of an entity. In some embodiments, rules may be applied to a segmented portion of activity of an entity such as Automated Teller Machine (ATM) activity, Prepaid activity, Point of Sale (POS) activity, ecommerce activity, and/or combinations thereof.

In some embodiments, even if transaction data 302 satisfies a rule, SAD computing device 102 may override the rule and not generate an alert because of other circumstances that account for the satisfaction of the rule. Examples of activity that is not considered to be suspicious may be stored as rule suspension data (e.g., rule suspension data 726) in database 110 and used by SAD computing device 102. Activity may not be suspicious if it occurs, as examples, during a particular season (e.g., during a holiday season), at popular travel destinations, at a popular event (e.g., a sporting event, concert, religious event, etc.), or is new activity (e.g., a new customers, new products, etc.). Further, SAD computing device 102 may override a rule in a particular instance if the same alert for the same entity was previously cleared (e.g., by a qualified operator/compliance team) as not suspicious (e.g., SAD computing device 102 compares alerts to previously cleared alerts, and may utilize artificial intelligence techniques). Suspending alerts conditionally allows business teams to monitor the alert trends for a period of time and make decisions to come up with new typology or modify an existing typology as needed. Some of the suspending alerts scenarios considered are for holidays in specific region, transfer of BINS, specific MCCs etc. Suspending alerts are based on rule, rule criteria, month, combination of criteria by region, network, typology, cross border, domestic, customer type or transaction type.

Upon determining transaction data 302 does not comply with rule data 310, SAD computing device 102 is configured to transmit an SAD output 312 (e.g., similar to or more complex than the charts shown in FIGS. 4A and 4B) to database 110. In the example embodiment, SAD computing device 102 is configured to generate a detailed report and a summarized report (as shown in FIGS. 2B and 2C). For example, an evaluator analyzing alerts generated by SAD computing device 102 may first analyze the summarized report, and then analyze portions of the detailed report if further investigation is required in order to determine if the generated alert does, in fact, indicate potentially suspicious activity.

For example, the detailed report includes all the alert outputs generated for all rules for different combination of customer types, transaction types etc. Reports and logic have been built in such a way that alerts are generated when a customer's activity exceeds the set thresholds for each of the rules. For example, for High Risk Country Cross border activity, alerts are generated when a customer's cross border activity at/from high risk countries exceeds the set thresholds. Similarly, activity is compared against customer's peer's average, to its own 3 months average and the users will be presented with the detail tracker which shows consolidated list of all alerts for past 16 months in a single master detail tracker. Alert scoring methodology is also displayed in detailed report which is calculated based on risk rating and rule score value. The summary report includes the summarized version of all alerts listed in the detailed report.

In the example embodiment, alerts are generated by SAD computing device 102 when a customer's activity exceeds set thresholds (percentage, amount, count, increase over time) for each of the rules. Each month, alerts are generated from preceding month's data. Alerts are assigned to analysts for further investigation to determine if they are legitimate or false positive. Alert outputs are stored in database (e.g., database 110) for a retention period of 5 years. Analysts may compare the customer alerts to previous alerts to determine if the customer has been subject of prior alerts, if the alert is related to prior alert or a different typology triggered. In some embodiments, SAD computing device 102 may send an alert to a suspect customer. SAD computing device 102 may also be configured to determine if the suspect customer has computing resources necessary to track and analyze transaction data associated with the suspect customer. In some embodiments, SAD computing device 102 may be configured to transmit recommendations to customers including instructions and methods for detecting suspect activity internally at a customer system.

In some embodiments, SAD computing device 102 may generate and transmit an alert message (e.g., including SAD output 312) to user computing device 106 to notify a qualified operator of user computing device 106 of potential money laundering activity. In some embodiments, a qualified operator of user computing device 106 may access database 110 and/or data warehouse 104 via SAD computing device 102 to find potential money laundering activity identified by SAD computing device 102 in SAD output 312.

In some embodiments, an operator of user computing device 106 may provide feedback regarding SAD output 312. For example, an operator of user computing device 106 may indicate that some of the alerts generated by SAD computing device 102 did identify money laundering activity, while some of the alerts generated by SAD computing device 102 did not accurately identify money laundering activity. Feedback from an operator of user computing device 106 may be transmitted from user computing device 106 to SAD computing device 102 as feedback data. SAD computing device 102 may then transmit the feedback to database 110 so that SAD computing device can use the feedback data when analyzing transaction data 302 and/or rule data 310 to identify suspect activity so that SAD computing device 102 determines suspect activity more accurately. In some embodiments, SAD computing device 102 is configured to modify rules and or rule data 310 based on the feedback data (e.g., by using artificial intelligence techniques).

FIG. 3B is a data flow block diagram 320 illustrating an example process of modifying rules by SAD computing device 102. To fine tune Rule 1A to better identify money laundering activity, X %, Y % as shown in FIG. 4C, and/or other thresholds and aspects of Rule 1A, or any other rule, may be modified. For example, rule suspension data as described above, may also be modified. In some embodiments, SAD computing device 102 may be configured to modify rule data by using, for example, artificial intelligence techniques. In some embodiments, a qualified operator (e.g., on a compliance team) of a user computing device may modify rule data. In some embodiments a qualified operator may be able to send sample transaction data and sample rule data to SAD computing device 102 in order to test how accurate certain rules and/or thresholds may be in helping SAD computing device 102 detect money laundering activity.

In the example shown in FIG. 3B, a user operating user computing device 106 may request rules by initiating a rule data request 322 transmitted from user computing device 106 to SAD computing device 102, and from SAD computing device 102 to database 110. SAD computing device 102 is configured to then receive rule data 324, including at least one rule as described herein, from database 110 and transmit rule data 324 to user computing device 106. In some embodiments, before transmitting rule data 324 to user computing device 106, SAD computing device 102 may be configured to verify the operator of user computing device 106 has the proper credentials to view rule data 324. For example, an operator/user of user computing device 106 may have to verify their credentials by entering a username, password, and/or biometric information (e.g., a fingerprint) at user computing device 106. SAD computing device 102 may be configured to then receive the information entered at user computing device 102, and validate an account associated with the operator of user computing device 102 indicating the operator has proper credentials to view rule data 324. In some embodiments, SAD computing device 102 may be configured to verify the authenticity of other devices, networks, databases, etc. as described herein.

Upon receipt of rule data 324, an operator of user computing device 106 may modify rule data 324 to generate modified rule data 326. For example, a certain threshold may be modified by an operator because too many false positives of money laundering alerts are being generated by SAD computing device 102. In some embodiments, SAD computing device 102 may be configured to modify rule data 324 by utilizing, for example, artificial intelligence techniques. Upon receipt of modified rule data 326, SAD computing device 102 transmits modified rule data 326 to database 110 for storage therein.

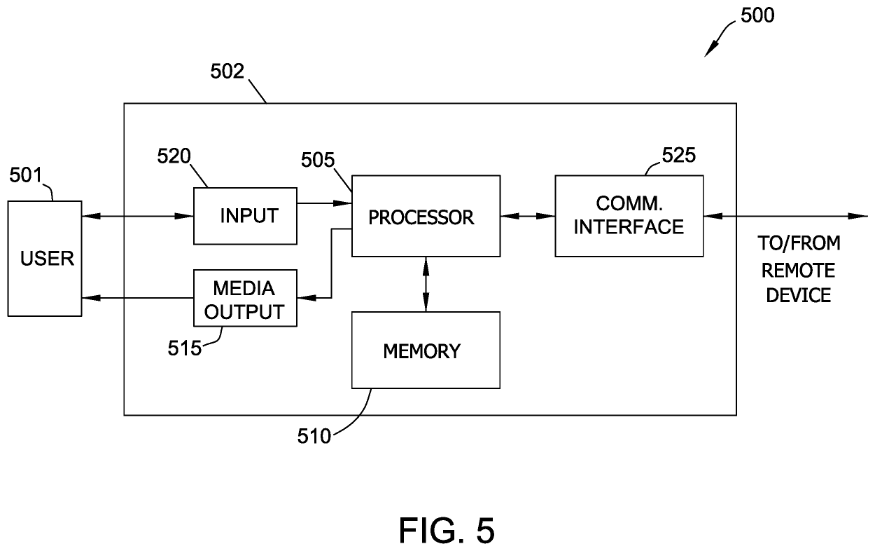

FIG. 5 illustrates an example configuration of a client computing device 502. Client computing device 502 may embody, but is not limited to, user computing device 106. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer-readable media.

Client computing device 502 also includes at least one media output component 515 for presenting information to a user 501 (e.g., merchant 24, shown in FIG. 1). Media output component 515 is any component capable of conveying information to user 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 502 includes an input device 520 for receiving input from user 501. Input device 520 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 515 and input device 520.

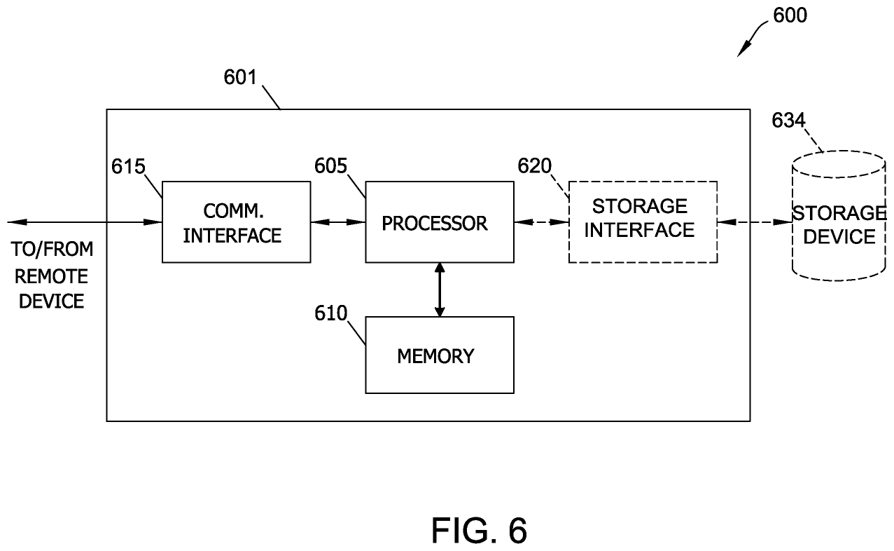

Client computing device 502 may also include a communication interface 525, which is communicatively couplable to a remote device such as a server system (e.g., server system 601 shown in FIG. 6) or a web server. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer-readable instructions for providing a user interface to user 501 via media output component 515 and, optionally, receiving and processing input from input device 520. A user interface may include, among other possibilities, a web browser and client application. Web browsers enable users 501 to display and interact with media and other information typically embedded on a web page or a website from a web server. A client application allows users 501 to interact with a server application associated with, for example, an automatic chargeback system. The user interface, via one or both of a web browser and a client application, facilitates displaying, for example, SAD output 312 generated by SAD computing device 102. The user may interact with the user interface to view and respond to, as examples, SAD output 312 and rule data 324 using input device 520.

FIG. 6 illustrates an example configuration of a server (host computing device) system 601 such as SAD computing device 102, used to, as examples, receive transaction data (e.g., transaction data 302), receive rule data (e.g., rule data 310), determine a portion of rule data to associate with a portion of transaction data, determine if the transaction data complies with the rule data, and generate a suspect activity alert message.

Server system 601 includes a processor 605 for executing instructions. Instructions may be stored in a memory area 610, for example. Processor 605 may include one or more processing units (e.g., in a multi-core configuration) for executing instructions. The instructions may be executed within a variety of different operating systems on the server system 601, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 605 is operatively coupled to a communication interface 615 such that server system 601 is capable of communicating with a remote device such as another server system 601. For example, communication interface 615 may receive requests (e.g., requests to view detailed reports and/or summarized reports generated by SAD computing device 102) from user computing device 106 via the Internet.

Processor 605 may also be operatively coupled to a storage device 634. Storage device 634 is any computer-operated hardware suitable for storing and/or retrieving data. In some embodiments, storage device 634 is integrated in server system 601. For example, server system 601 may include one or more hard disk drives as storage device 634. In other embodiments, storage device 634 is external to server system 601 and may be accessed by a plurality of server systems 601. For example, storage device 634 may include multiple storage units such as hard disks or solid state disks in a redundant array of inexpensive disks (RAID) configuration. Storage device 634 may include a storage area network (SAN) and/or a network attached storage (NAS) system. In some embodiments, server system 601 also includes database server 108 (shown in FIG. 2).

In some embodiments, processor 605 is operatively coupled to storage device 634 via a storage interface 620. Storage interface 620 is any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Memory area 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

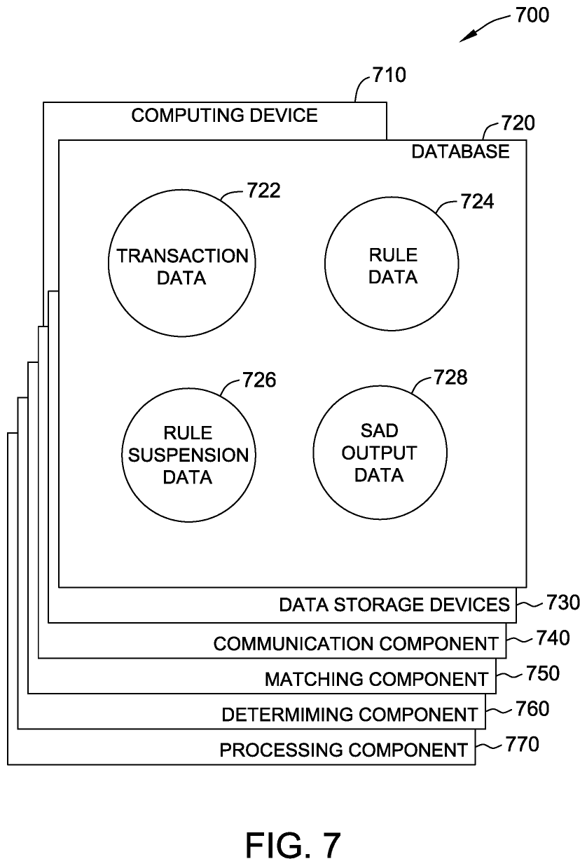

FIG. 7 is a diagram of components 700 of one or more example computing devices 710 (e.g., SAD computing device 102) that may be used in the environment shown in FIG. 2. Computing device 710 includes database 720 as well as data storage devices 730, a communication component 740, a matching component 750, a determining component 760, and a processing component 770. Database 720 may store information such as, for example, transaction data 722 (e.g., transaction data 302), rule data 724 (e.g., rule data 310), rule suspension data 726, SAD output data (e.g., SAD output 312), and/or other data. Database 720 is coupled to several separate components within SAD computing device 102, which perform specific tasks. In some embodiments, database 720 is substantially similar to database 110 (shown in FIG. 2).

Communication component 740 facilitates communication between computing device 710 and other systems. Matching component 750 is used to match transaction data with rule data, for example as described above with respect to FIG. 3. Determining component 760 is used to determine suspect activity (e.g., potential money laundering activity). Processing component 770 processes, as examples, transaction data, rule data, and the generation of suspect activity alert messages.

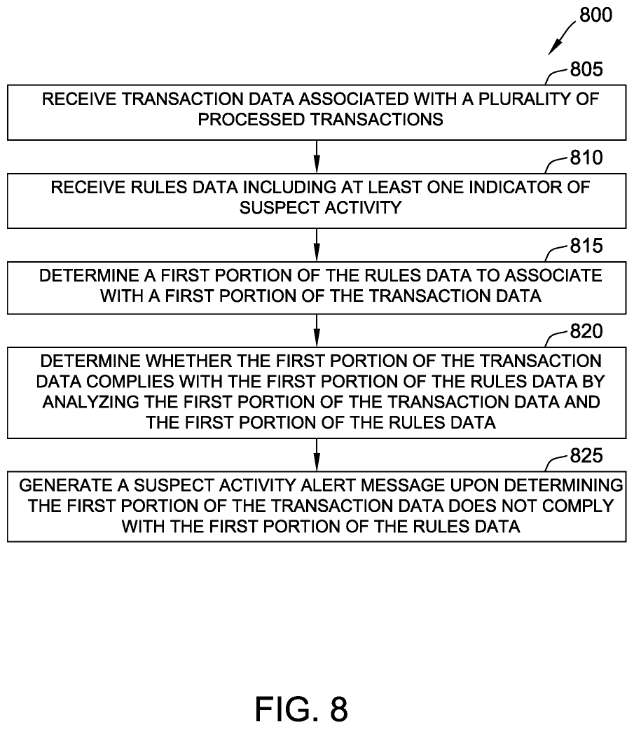

FIG. 8 illustrates a flow chart of an exemplary method 800 for detecting suspect activity and generating alerts using SAD computing system 100. Method 800 includes receiving 805 transaction data (e.g., transaction data 302) associated with a plurality of processed transactions, and receiving 810 rules data (e.g., rule data 310) including at least one indicator of suspect activity. Method 800 further includes determining 815 a first portion of the rules data to associate with a first portion of the transaction data, and determining 820 whether the first portion of the transaction data complies with the first portion of the rules data by analyzing the first portion of the transaction data and the first portion of the rules data. Method 800 also includes generating 825 a suspect activity alert message (e.g., SAD output 312) upon determining the first portion of the transaction data does not comply with the first portion of the rules data.

It should be recognized that the systems and methods described herein may be embodied in a variety of different manners, including the example embodiments described above. Further, the systems and methods may be tailored to monitor activity specific to different types of financial institutions, such as issuers, acquirers, Corporate and Government Institutions (CGIs), and service providers. Monthly alerts may be generated that are dispositioned, in a hierarchy level, involving multiple teams that have insight into the alerted customer (e.g., compliance, account, and business teams, etc.) to determine if the alerted activity is suspicious and/or determine if the customer the alert was generated for has adequate monitoring controls in place to detect the alerted activity. For example, customers having activity detected and indicated as suspicious may be more closely monitored In some embodiments, if activity is identified by SAD computing device 102 as suspect activity, SAD computing device 102 is configured to identify and deploy additional computing resources used to analyze transaction data for the parties associated with the suspect activity for at least a predefined period of time (e.g., months, years). For example, transaction data for the parties associated with suspect activity may be more closely monitored by SAD computing device 102 and/or additional computing resources than parties not previously associated with suspect activity.

In an example embodiment, five sets of network rules may be used to drive alert generation: High Risk Cross Border Activity, High Risk Merchant Categories, Unusual Patterns, Change in Behavior, and High Risk Customers. In some embodiments, more or less sets of network rules may be used. The rules capture high risk composition, changes in activity by aggregated transaction volume and/or transaction count, changes in activity over time, and changes in activity as compared to peers. The rules are applied to either the total aggregated transaction volume and/or transaction count of the customer or segmented by type of activity such as Automated Teller Machine (ATM), Prepaid, POS and ecommerce, or combinations thereof. The rules are each assigned a rule objective, a rule name, an alert level (e.g., types of customers, etc.), an alert type (e.g., domestic high risk, cross border high risk, total credits, total cash back (POS), etc.), a rule type (e.g., high risk cross border transactions, high risk transactions, credit refunds, domestic transactions, high risk domestic transactions, etc.), an evaluation level (e.g., customer, etc.), an evaluation trigger (e.g., monthly activity, previous three months activity, etc.), detection logic (e.g., specific rule/threshold logic), a recurrence frequency (e.g., monthly), default values (e.g., to indicate if cross border activity is being monitored by a given rule (e.g., Cross Border=Yes or No)), data source(s) (e.g., clearing, debit), and permutations (e.g., data from data source(s) one or more rules will be applied to). The following paragraphs include expanded descriptions of the rules utilized to generate alerts.

The High Risk Cross Border Activity rule set may include three different rules. For example, a first rule monitors a customer's cross border activity at high risk countries. Alerts are generated when a customer's cross border activity at/from high risk countries exceeds a set of thresholds. A second High Risk Cross Border Activity rule monitors the customer's high-risk cross border activity by comparing it to its peer group's high-risk cross border activity. Alerts are generated when a Customer's cross border activity at/from high risk countries exceeds the set thresholds. A third High Risk Cross Border Activity rule monitors the customer's high-risk cross border activity over time by calculating an increase of cross border activity in/from high risk countries compared to its own previous months. Alerts are generated when a Customer's increase of cross border activity at/from high risk countries exceeds the set thresholds.

The High Risk Merchant Categories rule set may include nine different rules. A first rule monitors the customer's domestic activity at high risk merchant category code. Alerts are generated when a customer's domestic activity at/from high risk category codes exceeds the set thresholds. A second rule monitors the customer's domestic activity at high risk merchant category codes (MCC) activity by comparing it to its peer group's high risk domestic High Risk MCCs activity. Alerts are generated when a customer's domestic activity. A third rule monitors the customer's domestic activity at high risk merchant category codes (MCC) over time by calculating an increase of domestic activity in/from high risk merchant category codes (MCC) compared to its own previous months. Alerts are generated when a Customer's increase of domestic activity at/from high risk category codes exceeds the set thresholds.

A fourth rule monitors the customer's cross border activity at high risk merchant category codes. Alerts are generated when a Customer's cross border activity at/from high risk category codes exceeds the set thresholds. A fifth rule monitors the customer's cross border activity at high risk merchant category codes (MCC) activity by comparing it to its peer group's high-risk cross border High Risk MCCs activity. Alerts are generated when a Customer's cross border activity at/from high risk category codes exceeds the set thresholds. A sixth rule monitors the customer's cross border activity at high risk merchant category codes (MCC) over time by calculating an increase of cross border activity in/from high risk merchant category codes (MCC) compared to its own previous months. Alerts are generated when a Customer's increase of cross border activity at/from high risk category codes exceeds the set thresholds.

A seventh rule monitors the Customer's High-risk merchant country activity at high risk merchant category. Alerts are generated when a Customer's High-risk merchant country activity at/from high risk category codes exceeds the set thresholds. An eighth rule monitors the Customer's High-risk merchant country activity at high risk merchant category codes (MCC) activity by comparing it to its peer group's high-risk cross border High Risk MCCs activity. Alerts are generated when a Customer's High-risk merchant country activity at/from high risk category codes exceeds the set thresholds. A ninth rule monitors the Customer's domestic activity at high risk merchant category codes (MCC) over time by calculating an increase of High-risk merchant country activity in/from high risk merchant category codes (MCC) compared to its own previous months. Alerts are generated when a Customer's increase of High-risk merchant country activity at/from high risk category codes exceeds the set thresholds.

In an example embodiment, high risk merchant categories may include the following examples: money transfer/payments, funding, precious stones and metals watches and jewelry, auto and truck dealers/leasers, boat dealers, camper dealers recreational and utility trailers, motorcycle shops and dealers, electronic sales, antique shops-sales repairs restoration services, pawn shops, antique reproduction stores, clock jewelry watch and silverware store, leather goods and luggage stores, and art dealers and galleries, stamp+coin stores-philatelic+numismatic supply, real estate agents and managers-rentals, timeshares, dating and escort services, massage parlors, detective-protective agency security srvs armor cars, organizations charitable and social services, organizations political, automated (ATM) and manual cash disbursements, quasi cash, insurance sales, securities-brokers-dealers, and gambling transactions.

The Unusual Patterns rule set may include two different rules. A first rule monitors the Customer's total Credit Refunds activity and compares it to its own total activity. Alerts are generated when a Customer's total Credit Refunds activity exceeds the set thresholds. A second rule monitors the Customer's total Cash Back (POS) activity and compares it to its own total activity. Alerts are generated when a Customer's total Cash Back (POS) activity exceeds the set thresholds.

The Change in Behavior rule set may include two different rules. A first rule monitors the Customer's total domestic activity over time by calculating an increase of domestic activity compared to its previous months. Alerts are generated when a Customer's increase of domestic activity exceeds the set thresholds. A second rule monitors the Customer's total cross border activity over time by calculating an increase of cross border activity compared to its previous months. Alerts are generated when a Customer's increase of cross border activity exceeds the set thresholds.

The High Risk Customer rule set may include two different rules. A first rule monitors the High-Risk Customer's total domestic activity over time by calculating an increase of domestic activity compared to its own previous months. Alerts are generated when a High-Risk Customer's increase of domestic activity exceeds the set thresholds.

A second rule monitors the High-Risk Customer's total cross border activity over time by calculating an increase of cross border activity compared to its own previous months. Alerts are generated when a High-Risk Customer's increase of cross border activity exceeds the set thresholds.

In the example embodiment, the rules are applied to transaction data each month. The SAD computing device as described herein is configured to analyze the transaction data based on the rules and generate at least a summary tracker report and a detail tracker report. The summary tracker report includes at least: Alert Month: Month of the alert; Alert Year: Year of the alert; Customer Name: Name of the alerted customer; Customer Type: The type of customer, or service provider; CID: Unique ID assigned to customers; Customer Region: Customer's headquartered region; Customer Country: Customer's headquartered country; Number of Alerts: Total number of alerts the customer triggered for in the alerted month; Alert Score, Previous 6 month Alerts Score, and Customer Risk Rating.

The detail tracker report includes at least: Alert Month: Month of the alert; Alert Year: Year of the alert; Customer Name: Name of the alerted customer; Customer Type; Customer Region; Customer Country; HR Customer: Indicates if the customer alerted has a risk rating; Indicates if alert was generated in Clearing or Debit Network; Rule type: Type of Activity Rule: Indicates which rule was triggered; Rule: Indicates which rule was triggered; Alert Triggered: Indicates if the thresholds for volume, count or both were exceeded; Alerted Amount: Transaction volume that triggered alert; and additional fields that explain the criteria of the rule.

In an example embodiment, the reports described above are the source for analysis through different levels of review to determine if the activity is suspicious or not.

A secondary level analysis may also be performed in addition to the first level analysis described above. In some embodiments, at least a portion of the secondary level analysis may be performed outside of the SAD computing device (e.g., by an analyst and/or at a different computing device).

In some embodiments, SAD computing device 102 may generate a risk score based on rule, transaction type (aka permutation) and customer risk rating. Weighted values are assigned to each of these elements and applied to each alert. Alert scores are then totaled for each customer and customers with the highest cumulative scores are investigated first.

In some embodiments, additional rules may be applied to transaction data. For example, a Round Amount rule monitors the total round amount activity. Alerts are generated when a Customer's round amount activity exceeds the set thresholds. As another example, an Under Threshold rule monitors high percentages of total volume where the transaction value is under potential reporting amounts.

A tuning process may also be performed on SAD computing system 100 and/or components therein (e.g., SAD computing device 102) to review of the typologies, rules, thresholds, permutations, false positive and suspicious alerts and data sources that the system utilizes to generate alerts. As examples, alert productivity is compared above and below the base line setting. If a rule is found to produce a high number of false positive alerts, consideration must be made to adjust thresholds. Conversely, if a rule is found not to yield meaningful alerts, thresholds are reconsidered for modification or, the rule is either replaced or retired. Various metrics may also be used in reviewing SAD computing system 100 and/or components therein.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

In some embodiments, including embodiments described wherein SAD computing device 102 utilizes artificial intelligence (AI) techniques, a processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. In some embodiments, AI may be layered on top of SAD computing device 102 instead of being built in to SAD computing device 102. Machine learning may involve identifying and recognizing patterns in existing data, such as feedback data, in order to facilitate making predictions for subsequent data, such as SAD output data (e.g., SAD output 312). Models may be created based upon example inputs in order to make valid and reliable predictions for novel inputs.

Additionally or alternatively, the machine learning programs may be trained by inputting sample (e.g., training) data sets or certain data into the programs, such as transaction data 302 and rule data 310 stored in database 110 and/or projected future transaction data and rule data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning. In the exemplary embodiment, data feeds back into the machine learning programs in real-time to update its set of parameters.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In the exemplary embodiment, machine learning techniques are used to predict SAD output data, and to output the predictions for storage in database 110.

In the exemplary embodiment, a processing element may be trained by providing it with a large sample of transaction data and rule data (e.g., regarding processed payments completed via different entities). Based upon these analyses, the processing element may learn how to identify characteristics and patterns that may then be applied to analyzing transaction data. For example, the processing element may learn to predict suspect activity from certain entities. Similarly, the processing element may also learn to identify which data elements of transaction data are more likely to indicate suspect activity than others.

In some embodiments, the processing element is trained to analyze a generated alert (e.g., an alert identified by SAD computing device 102 as described herein). For example, the processing element may be trained based on previous activity that was confirmed as suspicious, identified as a false-positive of suspicious activity, and/or activity that was confirmed as not suspicious. The processing element is configured to then analyze a given alert, and generate an analysis (e.g., a confidence score) indicating a probability that the given alert actually includes suspicious activity. For example, alerts including more highly suspicious activity are given a higher confidence score by the processing element than less suspicious activity. The processing element generating a confidence score for each alert helps SAD computing device 102 and/or an analyst be more efficient in identifying suspicious activity based on generated alerts. For example, an analyst will potentially spend more time analyzing an alert with a higher confidence score than an alert with a lower confidence score.

As used herein, the term “non-transitory computer-readable media” is intended to be representative of any tangible computer-based device implemented in any method or technology for short-term and long-term storage of information, such as, computer-readable instructions, computer-executable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible and fast system for various aspects of fraud analysis for registration of merchants with acquirer banks. Any such resulting program, having computer-readable code means, may be embodied or provided within one or more computer-readable media, thereby making a computer program product, e.g., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the suspect activity computing device are described herein as including general processing and memory devices, it should be understood that the suspect activity computing device is a specialized computer configured to perform the steps described herein for detecting suspect activity from transaction data.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A computing system for initiating a suspect activity alert, the computing system comprising at least one processor in communication with at least one memory, the at least one processor programmed to:
receive transaction data associated with a plurality of processed transactions;
receive rules data comprising at least one indicator of suspect activity;
determine a first portion of the rules data to associate with a first portion of the transaction data;
determine whether the first portion of the transaction data complies with the first portion of the rules data by analyzing the first portion of the transaction data and the first portion of the rules data; and
generate a suspect activity alert message upon determining the first portion of the transaction data does not comply with the first portion of the rules data.

2. The computing system of claim 1, wherein the at least one processor is further programmed to:
determine a second portion of the rules data to associated with a second portion of the transaction data;
determine whether the second portion of the transaction data complies with the second portion of the rules data by analyzing the second portion of the transaction data and the second portion of the rules data; and
generate a suspect activity alert message upon determining the second portion of the transaction data does not comply with the second portion of the rules data.

3. The computing system of claim 1, wherein the rules data comprises at least one suspect activity threshold.

4. The computing system of claim 3, wherein the at least one processor is further programmed to generate a suspect activity alert message if the first portion of the transaction data indicates activity above the at least one suspect activity threshold.

5. The computing system of claim 3, wherein the at least one processor is further programmed to generate a suspect activity alert message if the first portion of the transaction data indicates activity below the at least one suspect activity threshold.

6. The computing system of claim 1, wherein the at least one processor is further programmed to receive feedback data comprising an indication of whether the suspect activity alert message identified money laundering.

7. The computing system of claim 6, wherein the at least one processor is further programmed to modify the rules data based on the feedback data.

8. The computing system of claim 1, wherein the first portion of the rules data includes data analyzed by the at least one processor to determine whether the first portion of the transaction data includes unusual patterns indicative of money laundering.

9. The computing system of claim 1, wherein the first portion of the rules data includes data analyzed by the at least one processor to determine whether the first portion of the transaction data includes changes in transaction behavior indicative of money laundering.

10. The computing system of claim 1, wherein the first portion of the rules data includes data analyzed by the at least one processor to determine whether the first portion of the transaction data includes high risk customers indicative of money laundering.

11. A computer-implemented method for initiating a suspect activity alert, the method implemented by at least one suspect activity detection (SAD) computing device including at least one processor in communication with at least one database, the method comprising:
receiving transaction data associated with a plurality of processed transactions;
receiving rules data comprising at least one indicator of suspect activity;
determining a first portion of the rules data to associate with a first portion of the transaction data;
determining whether the first portion of the transaction data complies with the first portion of the rules data by analyzing the first portion of the transaction data and the first portion of the rules data; and
generating a suspect activity alert message upon determining the first portion of the transaction data does not comply with the first portion of the rules data.

12. The method of claim 11, wherein the method further comprises:
determining a second portion of the rules data to associated with a second portion of the transaction data;
determining whether the second portion of the transaction data complies with the second portion of the rules data by analyzing the second portion of the transaction data and the second portion of the rules data; and
generating a suspect activity alert message upon determining the second portion of the transaction data does not comply with the second portion of the rules data.

13. The method of claim 11, wherein the rules data comprises at least one suspect activity threshold.

14. The method of claim 11, wherein the method further comprises receiving feedback data comprising an indication of whether the suspect activity alert message identified money laundering.

15. The method of claim 14, wherein the method further comprises modifying the rules data based on the feedback data.

16. A non-transitory computer-readable storage medium having computer-executable instructions embodied thereon, wherein when executed by at least one suspect activity detection (SAD) computing device, including at least one processor in communication with at least one database, the computer-executable instructions cause the SAD computing device to:
receive transaction data associated with a plurality of processed transactions;
receive rules data comprising at least one indicator of suspect activity;
determine a first portion of the rules data to associate with a first portion of the transaction data;
determine whether the first portion of the transaction data complies with the first portion of the rules data by analyzing the first portion of the transaction data and the first portion of the rules data; and
generate a suspect activity alert message upon determining the first portion of the transaction data does not comply with the first portion of the rules data.

17. The computer-readable storage medium of claim 16, wherein the computer-executable instructions further cause the SAD computing device to:
determine a second portion of the rules data to associated with a second portion of the transaction data;
determine whether the second portion of the transaction data complies with the second portion of the rules data by analyzing the second portion of the transaction data and the second portion of the rules data; and
generate a suspect activity alert message upon determining the second portion of the transaction data does not comply with the second portion of the rules data.

18. The computer-readable storage medium of claim 16, wherein the rules data comprises at least one suspect activity threshold.

19. The computer-readable storage medium of claim 16, wherein the computer-executable instructions further cause the SAD computing device to receive feedback data comprising an indication of whether the suspect activity alert message identified money laundering.

20. The computer-readable storage medium of claim 19, wherein the computer-executable instructions further cause the SAD computing device to modify the rules data based on the feedback data.
